(19) United States
(12) Patent Application Publication
(10) Pub. No.: US 2023/0409159 A1
(43) Pub. Date: Dec. 21, 2023

(54) DISPLAY APPARATUS AND CONTROL METHOD THEREOF

(71) Applicant: SAMSUNG ELECTRONICS CO., LTD., Suwon-si (KR)

(72) Inventors: Haeree NA, Suwon-si (KR); Kihyoung SON, Suwon-si (KR); Jeongmin SON, Suwon-si (KR); Hyeonji LEE, Suwon-si (KR)

(73) Assignee: SAMSUNG ELECTRONICS CO., LTD., Suwon-si (KR)

(21) Appl. No.: 18/137,234

(22) Filed: Apr. 20, 2023

Related U.S. Application Data
(63) Continuation of application No. PCT/KR2023/003735, filed on Mar. 21, 2023.

(30) Foreign Application Priority Data
Jun. 21, 2022 (KR) 10-2022-0075576

(51) Int. Cl. G06F 3/0481; G06F 3/16

(52) U.S. Cl. CPC G06F 3/0481; G06F 3/165; G06F 2203/04803

(57) ABSTRACT

A display; and at least one processor operatively connected to the display and configured to: control the display to display first content, and based on receiving a command for executing second content, (i) compare a first priority associated with the first content with a second priority associated with the second content, (ii) display one content of the first content and the second content in a first area of the display based on the comparison of the first priority with the second priority, and (iii) control the display to display the other content of the first content and the second content on a second area of the display based on the comparison of the first priority with the second priority, wherein the first area is an area including a center of the display, and wherein the second area may include at least a portion of a remaining area excluding the first area of the display.

### CROSS-REFERENCE TO RELATED APPLICATION(S)

This application is a continuation of PCT/KR2023/003735, filed on Mar. 21, 2023, at the Korean Intellectual Property Receiving Office and claims priority under 35 U. S. C. § 119 to Korean Patent Application No. 10-2022-0075576, filed on Jun. 21, 2022, in the Korean Intellectual Property Office, the disclosure of which is incorporated by reference herein in its entirety.

### BACKGROUND

### 1. Field

The disclosure relates to a display apparatus and a control method thereof and, more particularly to, a display apparatus providing a multi-view function and a control method thereof.

### 2. Description of Related Art

An electronic device providing various functions is currently being developed in accordance with advancements of electronic technology. Recently, a display apparatus may provide a multi-view function, and a user may simultaneously view a plurality of contents through a multi-view function. For example, the display apparatus may provide two contents in two areas of the same size as illustrated in the upper left (100A) of FIG. 1A, or provide two contents in two areas of different sizes, as illustrated in the upper right (100B) of FIG. 1A, or provide three contents in three areas of the same size as illustrated in the lower left (100C) of FIG. 1A. Alternatively, the display apparatus may provide three contents in two areas having width longer than height and in one area having height longer than width, as the lower right (100D) of FIG. 1A.

The size and position of the area in which the contents are provided may be set in a preset state, and user convenience is ignored. In addition, in the case of a display apparatus having a large display (e.g., a display apparatus having a display of 55 inches or more), or a display apparatus having a specially-shaped display(e.g., a 32:9 ratio display), there is a significant problem in which a user is forced to view an edge of a display apparatus for a long time, thereby causing strain on a user's neck.

In the related-art, as shown in the left side of FIG. 1B, sound of one content in which a focus is located (e.g., screen B) is output through a plurality of speakers, or sounds of two contents in which a focus is positioned, as in the right side of FIG. 1B (screens A and B), are mixed and outputted through a plurality of speakers.

In the former case, a user watching a plurality of contents is inconvenienced since only one sound is provided. In the latter case, since the sounds of two contents are output through the speakers regardless of an area in which each of the two contents is displayed, the visual position and the sound position are different, and thus, there is a problem that a three-dimensional user experience is not achieved.

Accordingly, there is a need to develop technology to solve the above problem.

### SUMMARY

According to an aspect of the disclosure, a display apparatus may include: a display; and at least one processor operatively connected to the display and configured to: control the display to display first content, and based on receiving a command for executing second content, (i) compare a first priority associated with the first content with a second priority associated with the second content, (ii) display one content of the first content and the second content in a first area of the display based on the comparison of the first priority with the second priority, and (iii) control the display to display the other content of the first content and the second content on a second area of the display based on the comparison of the first priority with the second priority, wherein the first area is an area including a center of the display, and wherein the second area may include at least a portion of a remaining area excluding the first area of the display.

The at least one processor may be further configured to: control the display to display the first content on a third area of the display, based on receiving the command and based on a determination the first priority is higher than the second priority, control the display to display the first content in the first area and display the second content in the second area, and based on receiving the command and based on a determination the first priority is lower than the second priority, control the display to display the second content in the first area and display the first content in the second area.

The at least one processor may be further configured to identify the first priority based on a type of the first content and the second priority based on a type of the second content.

The at least one processor may be further configured to: control the display to display a focus on an edge of one of the first area and the second area; and based on the focus being located for a threshold time or more in the second area or receiving a command for selecting the second area in a state where the focus is located in the second area, control the display to display the other content in the first area and display the one content in the second area.

The display may be larger than or equal to a threshold size or at a preset ratio.

The display apparatus may further include: a plurality of speakers, wherein the at least one processor may be further configured to: output sound corresponding to the one content through a first speaker closer to the first area than the second area among the plurality of speakers, and output sound corresponding to the other content through a second speaker closer to the second area than the first area among the plurality of speakers.

The at least one processor may be further configured to increase a volume of the sound corresponding to the one content or reduce a volume of the sound corresponding to the other content.

The first content may be content mirrored with a user terminal, and the at least one processor may be further configured to, based on the user terminal receiving a call, mute the sound corresponding to the one content and reduce a volume of the sound corresponding to the other content.

The at least one processor may be further configured to, based on a preset event occurring in the other content, increase a volume of the sound corresponding to the other content.

The at least one processor may be further configured to change at least one of a size of the first area, a position of the first area, a size of the second area, or a position of the second area based on at least one of an arrangement state of the display or a resolution of the one content.

According to an aspect of the disclosure, a method of controlling a display apparatus, includes: displaying first content; receiving a command for executing second content; comparing a first priority associated with the first content with a second priority associated with the second content; and displaying one content of the first content and the second content in a first area of the display based on the comparing the first priority with the second priority, and displaying the other content of the first content and the second content on a second area of the display based the comparing of the first priority with the second priority, wherein the first area may be an area including a center of the display, and wherein the second area may include at least a portion of a remaining area excluding the first area of the display.

The displaying the first content may include displaying the first content on a third area of the display, and the displaying in the second area may include: based on receiving the command and based on a determination the first priority associated with the first content is higher than the second priority associated with the second content, displaying the first content in the first area and displaying the second content in the second area; and based on receiving the command and based on a determination the first priority associated with the first content is lower than the second priority associated with the second content, displaying the second content in the first area and display the first content in the second area.

The method may further include identifying the first priority based on a type of the first content and the second priority based on a type of the second content.

The method may further include: controlling the display to display a focus on an edge of one of the first area and the second area; and based on the focus being located for a threshold time or more in the second area or receiving a command for selecting the second area in a state where the focus is located in the second area, displaying the other content in the first area and display the one content in the second area.

The display may be larger than or equal to a threshold size or at a preset ratio.

According to an aspect of the disclosure, a display apparatus includes: a display; and at least one at least one processor connected to the display and configured to control the display apparatus, wherein the at least one processor may be further configured to: control the display to display first content, and based on receiving a command for executing second content, (i) compare a first priority associated with the first content with a second priority associated with the second content, (ii) display one content of the first content and the second content in a first area of the display based on the comparison of the first priority with the second priority, and (iii) control the display to display the other content of the first content and the second content on a second area of the display based on the comparison of the first priority with the second priority.

The at least one processor may be further configured to: control the display to display the first content on a third area of the display, based on receiving the command and based on a determination the first priority associated with the first content is higher than the second priority associated with the second content, control the display to display the first content in the first area and display the second content in the second area, and based on receiving the command and based on a determination the first priority associated with the first content is lower than the second priority associated with the second content, control the display to display the second content in the first area and display the first content in the second area.

The at least one processor may be further configured to identify the first priority based on a type of the first content and the second priority based on a type of the second content.

The at least one processor may be further configured to: control the display to display a focus on an edge of one of the first area and the second area; and based on the focus being located for a threshold time or more in the second area or receiving a command for selecting the second area in a state where the focus is located in the second area, control the display to display the other content in the first area and display the one content in the second area.

The display may be larger than or equal to a threshold size or at a preset ratio.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B are views illustrating a related art;

FIG. 2 is a block diagram illustrating a configuration of a display apparatus, according to one or more embodiments of the disclosure;

FIG. 3 is a block diagram illustrating a detailed configuration of a display apparatus according to one or more embodiments of the disclosure;

FIGS. 4 and 5 are views illustrating a field of view of a user according to one or more embodiments of the disclosure;

FIG. 6 is a diagram illustrating a first area and a second area according to one or more embodiments of the disclosure;

FIG. 7 is a diagram illustrating an operation of outputting image content and music content according to one or more embodiments of the disclosure;

FIG. 8 is a diagram illustrating an operation of outputting image content and music content, according to one or more embodiments of the disclosure;

FIG. 9 is a diagram illustrating an operation of outputting image content and game content according to one or more embodiments of the disclosure;

FIG. 10 is a diagram illustrating an operation of outputting image content, game content, and Internet content according to one or more embodiments of the disclosure;

FIG. 11 is a diagram illustrating volume of sound according to one or more embodiments of the disclosure;

FIG. 12 is a diagram illustrating an output of a plurality of sounds according to one or more embodiments of the disclosure;

FIGS. 13 and 14 are diagrams illustrating output of a plurality of sounds, according to one or more embodiments of the disclosure;

FIG. 15 is a diagram illustrating a mirroring operation according to one or more embodiments of the disclosure;

FIG. 16 is a diagram illustrating a mirroring operation, according to one or more embodiments of the disclosure;

FIG. 17 is a diagram illustrating a multilateral video call according to one or more embodiments of the disclosure; and

FIG. 18 is a flowchart illustrating a method for controlling a display apparatus according to one or more embodiments of the disclosure.

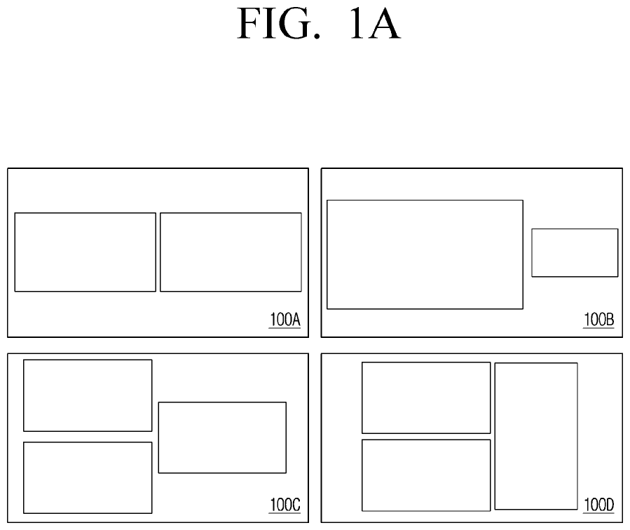

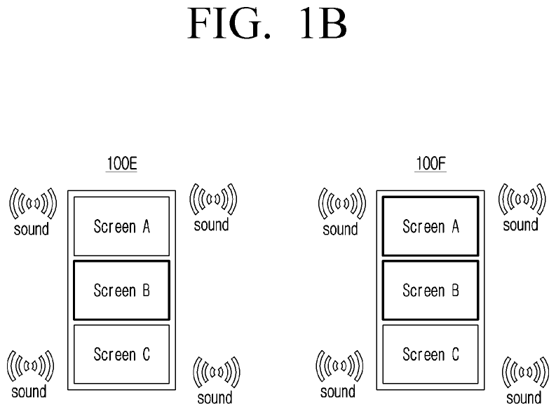

### DETAILED DESCRIPTION

Hereinafter, example embodiment of the disclosure will be further described with reference to the accompanying drawings. The example embodiments of the present disclosure may be diversely modified. Accordingly, specific example embodiments are illustrated in the drawings and are described in detail in the detailed description. However, it is to be understood that the present disclosure is not limited to a specific example embodiment, but includes all modifications, equivalents, and substitutions without departing from the scope and spirit of the present disclosure. Also, well-known functions or constructions are not described in detail since they would obscure the disclosure with unnecessary detail.

The disclosure provides a display apparatus providing a multi-view function in consideration of health condition of a user and three-dimensional user experience and a control method thereof.

The terms used in the present specification and the claims are general terms identified in consideration of the functions of the various embodiments of the disclosure. However, these terms may vary depending on intention, technical interpretation, emergence of new technologies, and the like of those skilled in the related art. Some terms may be selected by an applicant arbitrarily, and the meaning thereof will be described in the detailed description. Unless there is a specific definition of a term, the term may be construed based on the overall contents and technological understanding of those skilled in the related art.

In this specification, the expressions “have,” “may have,” “include,” or “may include” or the like represent presence of a corresponding feature (for example: components such as numbers, functions, operations, or parts) and does not exclude the presence of additional feature.

The expressions “at least one of A or B” and “at least one A and B” should be understood to represent only “A,” only “B,” or both of “A and B.”

As used herein, the terms “first,” “second,” or the like may denote various components, regardless of order and/or importance, and may be used to distinguish one component from another, and does not limit the components.

A singular expression includes a plural expression, unless otherwise specified. It is to be understood that the terms such as “comprise” or “consist of” are used herein to designate a presence of a characteristic, number, step, operation, element, component, or a combination thereof, and not to preclude a presence or a possibility of adding one or more of other characteristics, numbers, steps, operations, elements, components or a combination thereof.

In this disclosure, a term user may refer to a person using an electronic apparatus or an apparatus (for example: artificial intelligence (AI) electronic apparatus) that uses an electronic apparatus.

Hereinafter, embodiments of the disclosure will be described in detail with reference to the accompanying drawings.

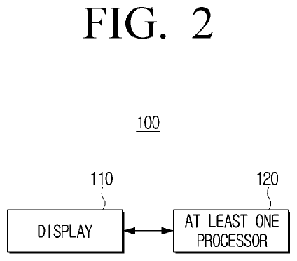

FIG. 2 is a block diagram illustrating a configuration of a display apparatus 100 according to one or more embodiments of the disclosure.

The display apparatus 100 may be an apparatus displaying contents such as a TV, a desktop PC, a notebook PC, a video wall, a large format display (LFD), a digital signage, a digital information display (DID), a projector display, a digital video disk (DVD) player, a refrigerator, a washing machine, a smartphone, a tablet PC, a monitor, a smart glasses, a smart watch, or any other display apparatus known to one of ordinary skill in the art.

Referring to FIG. 2, the display apparatus 100 includes a display 110 and at least one processor 120.

The display 110 may be configured to display an image and may be implemented as a display of various types such as, for example, a liquid crystal display (LCD), organic light emitting diodes (OLED) display, or plasma display panel (PDP). In the display 110, a backlight unit, a driving circuit which may be implemented as an a-si thin film transistor (TFT), low temperature poly silicon (LTPS) TFT, organic TFT (OTFT), or any other display structure known to one of ordinary skill in the art. The display 110 may be implemented as a touch screen coupled to a touch sensor, a flexible display, a third-dimensional (3D) display, or any other screen structure known to one of ordinary skill in the art.

The display 110 may be equal to or greater than a threshold size or may be a predetermined ratio. For example, the display 110 may be 55 inches or more, or one of the horizontal dimension and vertical dimension of the display may be greater than or equal to the other than the other, such as a 32:9 ratio.

According to one or more embodiments, at least one processor 120 controls the overall operation of the display apparatus 100. Specifically, the processor 120 may be connected to each component of the display apparatus 100 to control the overall operation of the display apparatus 100. For example, the at least one processor 120 may be connected to a configuration such as the display 110, a plurality of speakers, a memory, a communication interface, and the like to control the operation of the display apparatus 100.

The processor 120 according to one or more embodiments may be implemented with a digital signal processor (DSP), a microprocessor, and a time controller (TCON), or any other processor known to one of ordinary skill in the art, but the processor is not limited thereto. The processor 120 may include, for example, and without limitation, one or more among a central processor (CPU), a micro controller unit (MCU), a microprocessor unit (MPU), a controller, an application processor (AP), a communication processor (CP), an advanced reduced instruction set computing (RISC) machine (ARM) processor, a dedicated processor, or may be defined as a corresponding term. The processor 120 may be implemented in a system on chip (SoC) type or a large scale integration (LSI) type which a processing algorithm is built therein, or in a field programmable gate array (FPGA) type.

At least one processor 120 may be implemented with a plurality of processors. For convenience of description, an operation of the display apparatus 100 will be described with respect to the processor 120.

The processor 120 may control the display 110 to display a first content, and when a user command for executing a second content is received, compare priorities of the first content and the second content to display one content of the first content and the second content in a first area of the display 110, and control the display 110 to display the other content of the first content and the second content on a second area of the display 110. The first area may be an area including the center of the display 110, and the second area may include at least a part of the remaining areas except for the first area in the display 110.

For example, the processor 120 may control the display 110 to display the image content, display the image content in the first area when a user command for executing music content in addition to image content is received, and control the display 110 to display the music content in the second area.

The first area is an area including the center of the display 110 and may be a preset area in consideration of the field of view of the user. The second area may be all or part of the remaining areas except for the first area in the display 110. The first area and the second area will be described later with reference to the drawings.

The processor 120 may control the display 110 to display the first content on a third area of the display 110, control the display 110 to display the first content in the first area, and display the second content in the second area when the user command for executing the second content is received and the first content has a higher priority than the second content. The processor 120 may further control the display 110 to display the second content in the first area and display the first content in the second area when the user command for executing the second content is received and the priority of the first content is lower than the priority of the second content.

For example, the processor 120 may control the display 110 to display the image content on the entire area, which is a third area of the display 110, and when a user command for executing the music content is received, control the display 110 to display, in the first area, image content having a relatively high priority and display, in the second area, image content having a relatively lower priority. In this case, the display area of the image content may be changed from an entire area of the display 110 to a partial area, which is the first area, according to a user command for executing the music content. However, the embodiments are not limited thereto, and the third area may not be the entire area of the display 110. For example, the third area may be a partial area of the display 110, and may be an area different from the first area. In one or more examples, the display area of the first content may be changed according to a user command for executing the second content.

The processor 120 may identify a priority based on the type of the first content and the type of the second content. For example, since video content is highly likely to be accompanied by a user's viewing, a priority of the video content may be higher than that of music content. In one or more examples, a game content may have a higher priority than the image content since the game content is likely to require an active operation of the user.

However, the embodiments are not limited thereto, and the processor 120 may determine the priority by further considering at least one of the type of the content, the execution time of the content, the interaction of the user with respect to the content, or the execution history of the user for the content.

For example, the processor 120 may control the display 110 to display the first image content on the entire area which is a third area of the display 110, display, in the first area, first image content having a relatively long execution time of the content when a user command for executing the second image content is received, and control the display 110 to display, in the second area, second image content having a relatively short execution time. The priority of the content having a relatively long execution time may be higher than the priority of the content having a relatively short execution time in consideration of the continuity of the user's viewing.

The embodiments are not limited thereto and the processor 120 may control the display 110 to display the first image content on the entire area which is the third area of the display 110, display, in the first area, second image content having a relatively short execution time of the content when a user command for executing the second image content is received, and control the display 110 to display the first image content having the relatively long execution time in the second area. In this case, the priority of the content having a relatively short execution time may be higher than the priority of the content having a relatively long execution time in consideration of the intention of the user to view the new content.

In one or more examples, when the execution time of the executed content is greater than or equal to a threshold time, the priority of the content having the relatively short execution time may be higher than the priority of the content having the relatively short execution time. In one or more examples, if the execution time of the content that is to be executed in the future is less than the threshold time, the priority of the content having the relatively long execution time may be higher than the priority of the content having the relatively short execution time.

In one or more examples, the content may be received in a video bitstream that specifies the priority of the content. For example, each content may be specified with one of a plurality of priority levels.

The processor 120 may control the display 110 to display a focus on an edge of one of the first area and the second area, and when a user command for selecting the second area is received in a state where the focus is located for a period of time equal to a threshold time or more in the second area, or the focus is located in the second area, the processor 120 may control the display 110 to display the other content in the first area and display one content in the second area. For example, the user may change an area in which the content is displayed by using the focus.

The display apparatus 100 may further include a plurality of speakers. The processor 120 may output a sound corresponding to one content through a first speaker closer to the first area than a second area among the plurality of speakers, and output a sound corresponding to the other content through a second speaker closer to the second area than the first area among the plurality of speakers.

For example, the processor 120 may output image content in a first area, control the display 110 to output music content in a second area, output sound of the image content through a speaker disposed close to a first area among the plurality of speakers, and output sound of the music content through a speaker disposed near a second area among the plurality of speakers. Accordingly, the display apparatus 100 may provide an enhanced stereoscopic user experience.

The processor 120 may increase the volume of the sound corresponding to one content or reduce the volume of the sound corresponding to the other content. In one or more examples, the processor 120 may increase the volume of the sound corresponding to one content and reduce the volume of the sound corresponding to the other content.

For example, the processor 120 may increase the volume of the sound corresponding to the image content displayed in the first area or reduce the volume of the sound corresponding to the music content displayed in the second area. In one or more examples, the processor 120 may increase the volume of the sound corresponding to the image content displayed in the first area and reduce the volume of the sound corresponding to the music content displayed in the second area. This operation enhances the user's ability to focus more on the image content.

The first content may be content that is mirrored with the user terminal, and when the user terminal receives a call, the processor 120 may mute the sound corresponding to one content, and reduce the volume of the sound corresponding to the other content.

For example, the processor 120 may receive image content from a user terminal and mirror the image content through a first area. In this case, when the user terminal receives a call, the processor 120 may receive a signal indicating that the phone call is received from the user terminal, mute the sound of the image content, and reduce the volume of the sound corresponding to the content displayed in the second area.

However, the embodiments are not limited thereto, where when the first content is mirrored with a user terminal, the processor 120 may mute sound corresponding to all content when the user terminal receives a call.

When a preset event occurs in content other than the first content (e.g., other content), the processor 120 may increase a magnitude of sound corresponding to the other content.

For example, the processor 120 may output game content through a first area and output image content through a second area. The image content may be a soccer game image. The processor 120 may identify a scoring situation during a soccer game and increase the magnitude of a sound corresponding to the soccer game.

According to one or more embodiments, the location and/or size of the first area and the second area may be changed. For example, the processor 120 may change at least one of the size of the first area, the location of the first area, the size of the second area, or the location of the second area based on at least one of the arrangement state of the display 110 or the resolution of one content.

For example, when the display 110 is pivoted (e.g., display 110 may be rotated), the processor 120 may reduce the size of the first area and move the position further downward. The processor 120 may change the size and position of the second area according to the size and position change of the first area.

The processor 120 may change a speaker to output sound based on at least one of the arrangement state of the display 110 or the resolution of one content.

The processor 120 may adjust the volume of the sound corresponding to each content based on the usage pattern of the user. For example, when the volume-up history is present while the music content is displayed in the second area, the processor 120 may automatically increase a volume of the sound of the music content when the music content is displayed in the second area.

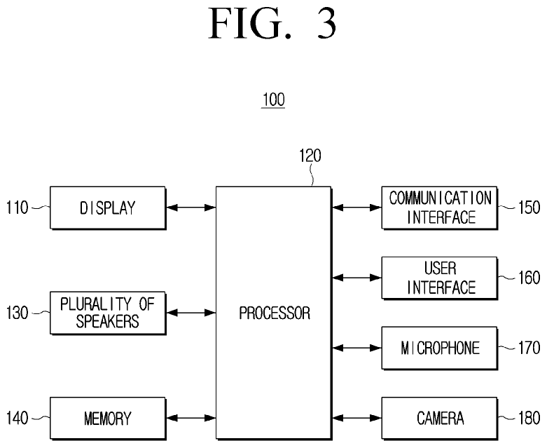

FIG. 3 is a block diagram illustrating a detailed configuration of a display apparatus 100 according to one or more embodiments of the disclosure. The display apparatus 100 may include the display 110 and a processor 120. Furthermore, according to FIG. 3, the display apparatus 100 may further include a plurality of speakers 130, a memory 140, a communication interface 150, a user interface 160, a microphone 170, and a camera 180. Among the components illustrated in FIG. 3, a detailed description of parts overlapping with the components illustrated in FIG. 2 will be omitted.

A plurality of speakers 130 may be configured to output various alarm sounds, voice message, or any other sounds, in addition to various audio data processed by the processor 120.

A plurality of speakers 130 may be implemented to be spaced apart from each other. For example, the plurality of speakers 130 may include a first speaker and a second speaker, the first speaker may be disposed on the left side of the display 110, and the second speaker may be disposed on the right side of the display 110. However, the embodiments are not limited thereto, and the number and arrangement states of the plurality of speakers 130 may vary.

The memory 140 may refer to a hardware that stores information such as data as an electric or magnetic form so that the processor 120, or any other component, may access the memory 140. The memory 140 may be implemented as at least one hardware among a non-volatile memory, a volatile memory, a flash memory, a hard disk drive (HDD) or solid state drive (SSD), random access memory (RAM), read-only memory (ROM), or any other memory structure known to one of ordinary skill in the art.

The memory 140 may store at least one instruction, program, or data used for operation of the display apparatus 100 or the processor 120. The instruction may be a code unit that directs the operation of the display apparatus 100 or the processor 120, and may be written in a machine language that may be understood by a computer. In the memory 140, a plurality of instructions to perform a particular task of the display apparatus 100 or the processor 120 may be stored in the memory 140 as an instruction set.

The memory 140 may store data which may be information in bit unit or byte unit that may represent characters, numbers, images, or any other data type known to one of ordinary skill in the art. For example, the memory 140 may store at least one of image content, game content, music content, or document content.

The memory 140 may store information about layout, sound, or other information known to one of ordinary skill in the art regarding the output of video or audio content.

The memory 140 may be accessed by the processor 120, and reading/writing/modifying/updating of data by the processor 120 may be performed associated with the instructions, instruction set or data.

The communication interface 130 may communicate with other external devices using various types of communication methods. For example, the display apparatus 100 may communicate with a server or a user terminal through the communication interface 150.

The communication interface 130 may include a Wi-Fi module, a Bluetooth module, an infrared communication module, a wireless communication module, or any other wireless communication circuitry known to one of ordinary skill in the art. Each communication module may be implemented as at least one hardware chip.

The Wi-Fi module and the Bluetooth module perform communication using a Wi-Fi method and a Bluetooth method, respectively. When using the Wi-Fi module or the Bluetooth module, various connection information such as a service set identifier (SSID) and a session key may be transmitted and received first, and communication information may be transmitted after communication connection. The infrared ray communication module may perform communication according to infrared data association (IrDA) technology that transmits data wireless to a local area using infrared ray between visible rays and millimeter waves.

The wireless communication module may include at least one communication chip performing communication according to various communication standards such as Zigbee, 3^{rd} generation (3G), 3^{rd} generation partnership project (3GPP), long term evolution (LTE), LTE advanced (LTE-A), 4^{th} generation (4G), 5^{th} generation (5G), or any other communication standard known to one of ordinary skill in the art, in addition to the communication modes described above.

The communication interface 150 may include wired communication interface such as the high-definition multimedia interface (HDMI), display port (DP), Thunderbolt, universal serial bus (USB), red, green, and blue (RGB), d-subminiature (D-SUB), digital visual interface (DVI), or any other wired communication circuitry known to one of ordinary skill in the art.

The communication interface 150 may also include at least one of a local area network (LAN) module, Ethernet module, or wired communication module performing communication using a pair cable, a coaxial cable, an optical cable, or any other network circuitry known to one of ordinary skill in the art.

The user interface 160 may be implemented as a button, a touch pad, a mouse, and a keyboard, etc., or as a touch screen that can perform both of the aforementioned display function and a manipulation input function. A button may be various types of buttons such as a mechanical button, a touch pad, a wheel, etc. formed in any areas such as the front surface part, the side surface part, the rear surface part, etc. of the exterior of the main body of the display apparatus 100.

The microphone 170 may be configured to receive a sound and convert the sound into an audio signal. The microphone 170 may be electrically connected to the processor 120 and receive a sound under the control of the processor 120.

For example, the microphone 170 may be integrally formed as an integral unit on at least one of an upper side, a front side direction, a side direction, or the like of the display apparatus 100. The microphone 170 may be provided in a remote control separate from the display apparatus 100. The remote control may receive sound through the microphone 170 and may provide the received sound to the display apparatus 100.

The microphone 170 may include various configurations such as a microphone for collecting user voice in an analog format, an amplifier circuit for amplifying the collected user voice, an audio-to-digital (A/D) conversion circuit for sampling the amplified user voice to convert into a digital signal, a filter circuitry for removing a noise element from the converted digital signal, or any other processing equipment known to one of ordinary skill in the art.

The microphone 170 may be implemented with a form of a sound sensor or any type that may collect sound.

The processor 120 may identify a speaker to output sound corresponding to the content among a plurality of speakers based on the user's voice received through the microphone 170.

The display apparatus 100 may further include the camera 180. The camera 180 may be configured to capture a still image or a moving image. The camera 180 may capture a still image at a specific point in time, but may also continuously capture the still image.

The camera 180 may capture the front of the display apparatus 100 to capture a user watching the display apparatus 100. The processor 120 may identify an area to which the content is to be output based on the image of the user captured through the camera 180.

According to one or more embodiments, the camera 180 includes a lens, a shutter, an aperture, a solid-state imaging device, an analog front end (AFE), and a timing generator (TG). The shutter adjusts the time at which the light reflected by the subject enters the camera 120, and the aperture adjusts the amount of light incident on the lens by mechanically increasing or decreasing the size of an opening through which the light enters. The solid-state imaging device outputs an image by a photoelectric charge as an electric signal when the light reflected on the subject is accumulated as the photoelectric charge. TG outputs a timing signal for reading out pixel data of the solid-state imaging device, and AFE samples and digitizes the electrical signal output from the solid-state imaging device.

As described above, when a multi-view function is provided, the display apparatus 100 may display content having a higher priority in the central portion of the display, and determine a speaker to output sound of the content based on the display position of the content from among the plurality of speakers, thereby improving user convenience.

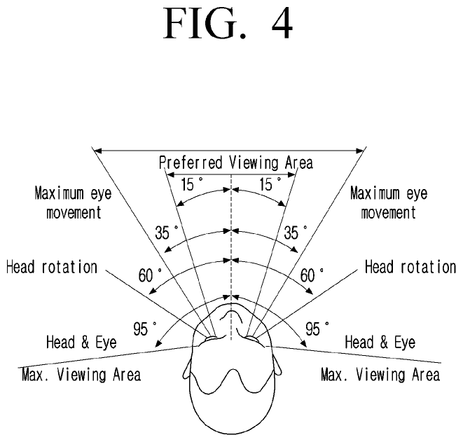

An operation of the display apparatus 100 will be described in more detail with reference to FIGS. 4 to 17. In FIGS. 4 to 17, individual embodiments will be described for convenience of description. However, the individual embodiments of FIGS. 4 to 17 may be performed in a combined state.

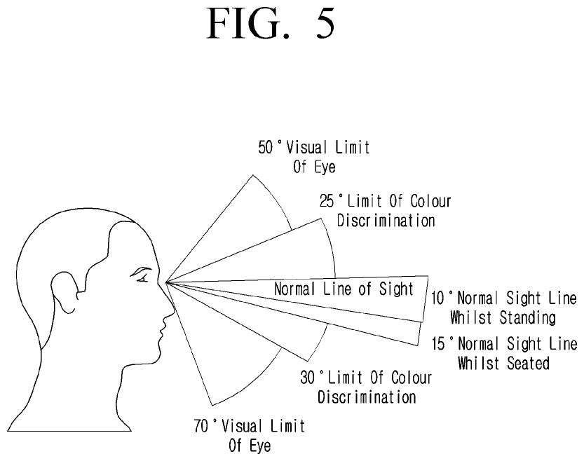

FIGS. 4 and 5 are example views illustrating a field of view of a user, according to one or more embodiments of the disclosure.

The first area may be in a state determined in the process of manufacturing the display apparatus 100 based on the field of view of the user. For example, as shown in FIG. 4, the horizontal field of view of the user may be an appropriate field of view that at the degree of 30 degrees (left 15 degrees, right 15 degrees), where a user may observe the display 110 without movement of the neck. Furthermore, the vertical field of view of the user may be an appropriate field of view that at the degree of 55 degrees (up 25 degrees, down 30 degrees), where a user may observe the display 110 without movement of the neck, as shown in FIG. 5. The first area may be a state determined based on the appropriate field of view.

Furthermore, the first area may be determined in consideration of the type of the display apparatus 100. For example, when the display apparatus 100 is a TV, the first area may be determined to be wider as the proper viewing distance (for example, 2.5 m for 55 inches) according to the display size is secured. However, when the display apparatus 100 is a monitor, the first area may be determined to be narrower in consideration of the use within 1 m.

The second area may be determined based on the first area.

The processor 120 is not limited to the above described functions, and the processor 120 may provide a UI for changing the first area. For example, the first area may be determined in a manufacturing process of the display apparatus 100, or the processor 120 may provide a UI for initial setting to the user to provide a UI for enlarging or reducing the initially determined first area. In one or more examples, the processor 120 may provide a UI for stepwise enlargement or reduction based on the field of view information of FIGS. 4 and 5.

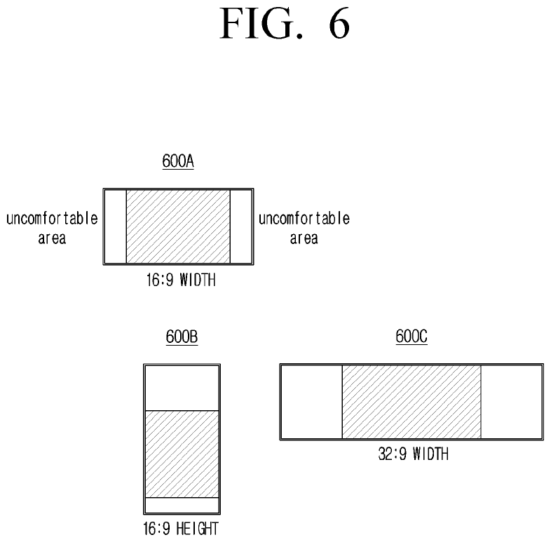

FIG. 6 is a diagram illustrating a first area and a second area according to one or more embodiments of the disclosure.

The upper figure of FIG. 6 shows a case (600A) in which the display 110 of 16:9 has a longer width. Since the display 110 of 16:9 has a longer width, the user's neck may be burdened in order to view both ends. Accordingly, an area with slash lines in the display 110 of 16:9 may be a first area as a comfortable area, and the remaining area not including the first area may be set as a second area as an uncomfortable area. The lower left drawing of FIG. 6 shows a case (600B) where the display 110 of 16:9 has a longer height, where in this case, in order to view the upper end, a burden may be applied to the neck of the user. Accordingly, when the display 110 of 16:9 has a longer height than width, the first area may be determined to be lower than when the display 110 of 16:9 has a longer width.

The processor 120 may change at least one of the position and size of the first area according to the arrangement state of the display 110 even when the same type of display 110 is used. Furthermore, the processor 120 may change the second area as the first area is changed.

The lower right figure of FIG. 6 is the display 110 of 32:9 ratio (600C), and a 32:9 display 110 has a loner width such that a user's neck may be burdened to view both ends. Accordingly, the hatched portion in the display 110 of 32:9 is the first area, and the remaining area may be set as the second area.

In FIG. 6, the first area and the second area may be determined at the time of manufacture, but the embodiments are not limited thereto. For example, the processor 120 may change at least one of a position or a size of the first area based on the type of the content, the position of the focus, or the resolution of the content, and determine the second area based on the changed first area. In one or more examples, when the position of the focus is changed from the first area to the second area, the processor 120 may enlarge the size of the second area and reduce the size of the first area. As illustrated in FIG. 6, the second area is segregated onto opposite sides of the first area. However, as understood by one of ordinary skill in the art, the first area may be a contiguous area positioned on one side of the display while the second area is a contiguous area displayed on the opposite of the first area.

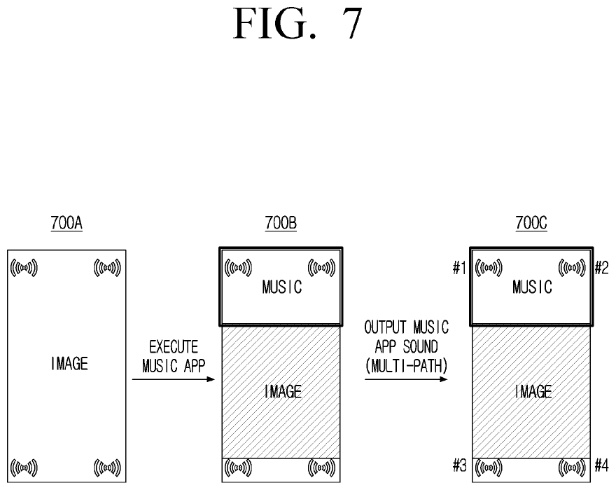

FIG. 7 is a diagram illustrating an operation of outputting image content and music content according to one or more embodiments of the disclosure.

The processor 120 may control the display 110 to display the first content, and when a user command for executing the second content is received, compare priorities of the first content and the second content to display one content of the first content and the second content in a first area of the display 110, and control the display 110 to display the other content of the first content and the second content on a second area of the display 110.

For example, the processor 120 may control the display 110 to display image content, as shown on the left side of FIG. 7 (700A). In this case, the processor 120 may control the display 110 to display the image content on the entire area. In addition, the display apparatus 100 includes four speakers, and the processor 120 may output sound corresponding to the image content through four speakers.

When a user command for executing music content is received as shown in the middle of FIG. 7 (700B), the processor 120 may display image content having a high priority on the first area and display music content having a lower priority on the second area. The second area from which the music content is output may be an upper area that is a larger area of an upper area and a lower area of the image content. As shown in the right side of FIG. 7 (700C), the processor 120 may output a sound corresponding to the image content through two lower speakers and output a sound corresponding to the music content through two speakers. The processor 120 may determine a speaker to output a sound corresponding to the content based on the distance between the speaker and the area from which the content is output.

The content may have a higher priority in the order of music content>text content>image content>video content>game content. The embodiments are not limited thereto, and the processor 120 may change the priority between content based on the usage pattern of the user.

The processor 120 may output sound in further consideration of focus of the user. For example, the processor 120 may output a sound corresponding to the music content through two speakers at the top, as a focus is positioned in the music content displayed in the second area. When the focus is located in the image content, the processor 120 may output a sound corresponding to the image content through the four speakers and without outputting a sound corresponding to the music content.

However, the embodiments are not limited thereto, and the processor 120 may output a sound corresponding to the image content through two speakers at the lower part regardless of the position of the focus, and output a sound corresponding to the music content through two speakers at the upper part.

When a user command for executing music content is received, the processor 120 may display image content having a high priority on a first area, provide a UI for displaying music content having a lower priority in a second area, display the image content in the first area according to the approval of the user, and control the display 110 to display the music content in the second area.

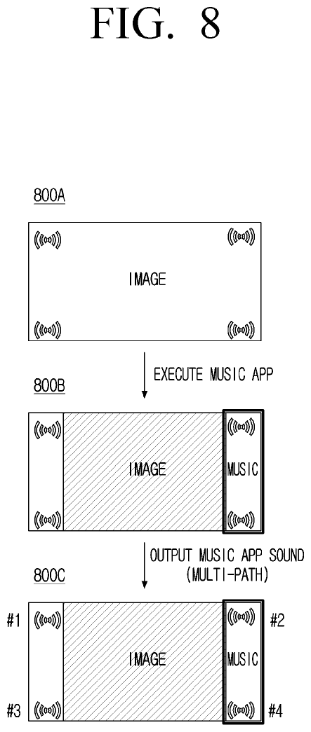

FIG. 8 is a diagram illustrating an operation of outputting image content and music content according to one or more embodiments of the disclosure. FIG. 8 illustrates that the display 110 of FIG. 7 is long in width.

The processor 120 may control the display 110 to display the first content, and when a user command for executing the second content is received, compare priorities of the first content and the second content to display one content of the first content and the second content in a first area of the display 110, and control the display 110 to display the other content of the first content and the second content on a second area of the display 110.

For example, as shown in the upper side of FIG. 8 (800A), the processor 120 may control the display 110 to display the image content. In this case, the processor 120 may control the display 110 to display the image content on the entire area. The display apparatus 100 may include four speakers, and the processor 120 may output sound corresponding to the image content through four speakers.

When a user command for executing music content is received as shown in the middle of FIG. 8 (800B), the processor 120 may display image content having a high priority on the first area and display music content having a lower priority on the second area. The second area from which the music content is output may be one of a left area and a right area of the image content, and is displayed as a right area in FIG. 8, for example. Furthermore, as shown in the lower side of FIG. 8 (800C), the processor 120 may output sound corresponding to the image content through two speakers on the left side and output sound corresponding to the music content through two speakers on the right side. The processor 120 may determine a speaker to output a sound corresponding to the content based on the distance between the speaker and the area from which the content is output.

The processor 120 may output sound in further consideration of focus. For example, the processor 120 may output a sound corresponding to the music content through two speakers of the right end, as a focus is placed in the music content displayed in the second area. When the focus is located in the image content, the processor 120 may output a sound corresponding to the image content through the four speakers without outputting a sound corresponding to the music content.

However, the embodiments are not limited thereto, and the processor 120 may output, regardless of the position of the focus, sound corresponding to the image content through two speakers on the left, and output sound corresponding to the music content through two speakers on the right side.

When a user command for executing the music content is received, the processor 120 may control the display 110 to display image content having a high priority on the first area and display music content having a lower priority on the second area, display the image content in the first area according to the approval of the user, and display the music content in the second area.

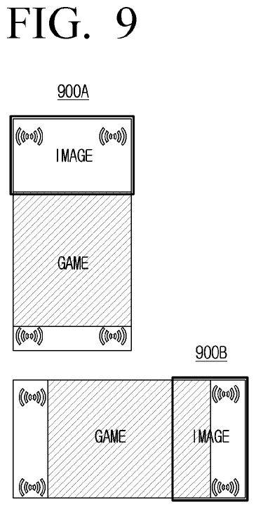

FIG. 9 is a diagram illustrating an operation of outputting image content and game content according to one or more embodiments of the disclosure.

As shown in the upper part of FIG. 9 (900A), the processor 120 may display the game content in a first area and display the image content in a second area, output a sound corresponding to the game content through two lower speakers, and output a sound corresponding to the image content through two upper speakers.

The processor 120 may control the display 110 to display one of the first content and the second content on a portion of the first area based on the type of the first content and the type of the second content, and to display the other one of the first content and the second content in the remaining portion of the first area and the second area based on the type of the first content and the type of the second content when the arrangement state of the display 110 is changed as shown in the lower end of FIG. 9 (900B).

For example, the processor 120 may control the display 110 to display the game content on the left portion in the first area and display the image content in the remaining right portion and the second area of the first area. As illustrated in the lower end of FIG. 9 (900C), the entire image content does not fit in the second area. However, when all of the two contents are important contents where visual elements are important, the processor 120 may control the display 110 to display the contents displayed on the second area in a larger area.

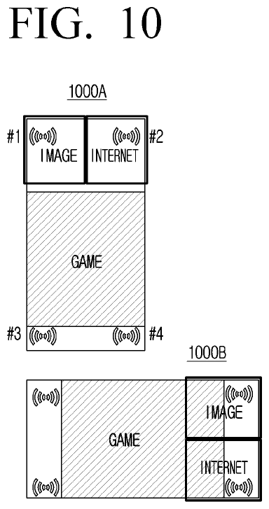

FIG. 10 is a diagram illustrating an operation of outputting image content, game content, and Internet content according to one or more embodiments of the disclosure.

The processor 120 may control the display 110 to display the first content in the first area and to display the second content in the second area. When a user command for executing the third content is received, the processor 120 may compare priorities of the first content, the second content, and the third content to display one content of the first content, the second content, and the third content in a first area of the display 110, and control the display 110 to display the remaining content on a second area of the display 110.

For example, when the display 110 has a longer height, the processor 120 may control the display 110 to display the game content on the first area and display the video content in the second area. When a user command for executing the Internet content is received, the processor 120 may control the display 110 to display the game content having the highest priority on the first area and display the image content and the Internet content on the second area, as shown in the upper end of FIG. 10 (1000A). The processor 120 may output sound corresponding to the game content through two lower speakers, output sound corresponding to the image content through a speaker at the left upper part, and output a sound corresponding to the Internet content through a speaker on the right upper part. When there is no sound corresponding to the Internet content, the processor 120 may output sound corresponding to the image content through two speakers. When the sound of the Internet content is identified, the processor 120 may output sound corresponding to the image content through a speaker at a left upper end, and output a sound corresponding to the Internet content through a speaker at a right upper end.

When the display 110 has a longer width, the processor 120 may control the display 110 to display the game content on a partial area of the first area and display the video content in the remaining area and the second area of the first area. When a user command for executing the Internet content is received, the processor 120 may control the display 110 to display the game content having the highest priority on a partial area of the first area and display the image content and the Internet content in the remaining area and the second area of the first area, as shown at the lower end of FIG. 10 (1000B). The processor 120 may output sound corresponding to the game content through two speakers on the left side, output sound corresponding to the image content through a speaker on the upper right side, and output a sound corresponding to the internet content through a speaker in the right lower part. When there is no sound corresponding to the Internet content, the processor 120 may output sound corresponding to the image content through two speakers on the right side. When the sound of the Internet content is identified, the processor 120 may output sound corresponding to the image content through a speaker at a left upper part, and output sound corresponding to the Internet content through a speaker at a right upper part.

The user may change content displayed in the first area through a user command that changes a focus on one of the areas. For example, when a user command to select image content after the focus is positioned in the image content is received, the processor 120 may change the position of the display of the image content and game content. In one or more examples, the processor 120 may change the area in which the content is displayed when the user is captured by the camera 180 and a preset motion is identified from the user.

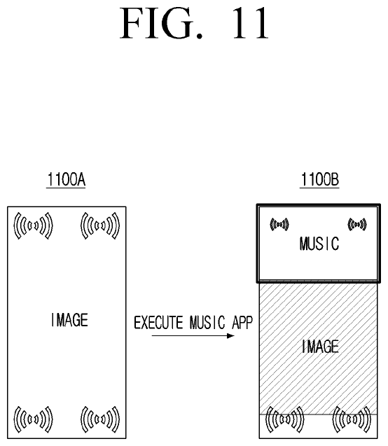

FIG. 11 is a diagram illustrating volume of sound, according to one or more embodiments of the disclosure.

The processor 120 may control the display 110 to display the first content in the first area and to display the second content in the second area. The processor 120 may output sound corresponding to the first content through a first speaker closer to the first area than a second area among the plurality of speakers 130, and output a sound corresponding to the second content through a second speaker closer to the second area than the first area among the plurality of speakers 130. The processor 120 may increase the volume of the sound corresponding to the first content or reduce the volume of the sound corresponding to the second content.

For example, as illustrated in FIG. 11, when music content is received, the processor 120 may control the display 110 to change from the entire display area displaying the image content (1100A) to display the image content on the first area and display the music content in the second area (1100B). The processor 120 may output sound corresponding to the image content through two lower speakers and output sound corresponding to the music content through two upper speakers. In one or more examples, the processor 120 may decrease volume of an output sound corresponding to the music content.

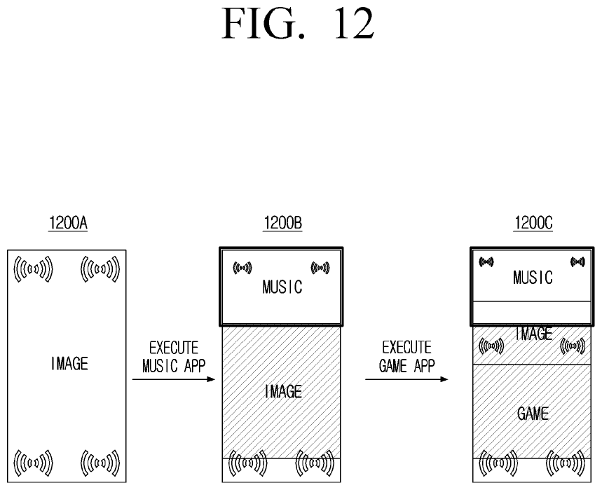

FIG. 12 is a diagram illustrating an output of a plurality of sounds, according to one or more embodiments of the disclosure. The left side of FIG. 12 (1200A) illustrates only the output of an image. The middle of FIG. 12 (1200B) illustrates the output of the image and the image. The right side of FIG. 12 (1200C) illustrates the output of game content, the image, and music.

The processor 120 may display the first content on a partial area of the first area, display the second content on the remaining area of the first area and a partial area of the second area, and display the third content on the remaining area of the second area.

For example, as shown in the right drawing of FIG. 12 (1200C), the processor 120 may display the game content on a partial area of the first area, display the image content on a remaining area of the first area and a partial area of the second area, and display the music content on the remaining area of the second area. The processor 120 may output sound corresponding to the game content through two lower speakers, and output sound corresponding to the image content and a sound corresponding to the music content through two other speakers. The sound corresponding to the image content may have a volume greater than a sound corresponding to the music content. In FIG. 12, the sound corresponding to the image content may be output from the middle of the display 110, however, the sound corresponding to the image content may be output through two speakers at the upper part.

When the processor 120 displays the first content, the second content, and the third content, the processor 120 may identify an area to display the remaining content based on the type of the remaining two content excluding the content having the highest priority. For example, when the remaining two contents are image contents and Internet contents, as shown in the upper part of FIG. 10 (1000A), the processor 120 may display the image contents and the Internet contents in the second area. In one or more examples, when the remaining two contents are image contents and music contents as in the right side of FIG. 12 (1200C), the processor 120 may display the image contents and the music contents on the remaining area and the second area of the first area. The processor 120 may identify an area in which the content is to be displayed by determining whether the user's viewing is necessary versus whether the user's viewing is not necessary.

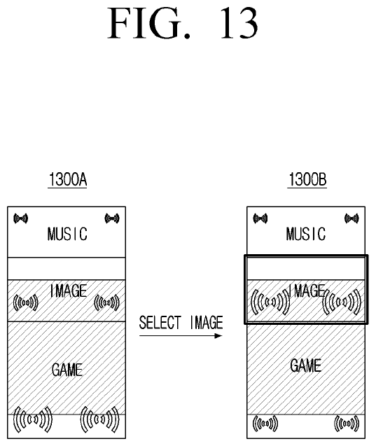

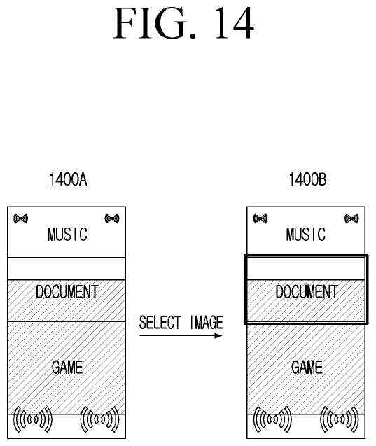

FIGS. 13 and 14 are diagrams illustrating output of a plurality of sounds according to one or more embodiments of the disclosure.

The left side of FIG. 13 (1300A) is the same as the right side of FIG. 12 (1200C). In a state in which the processor 120 operates as in the left side of FIG. 13, when a user command for selecting the image content is received, the processor 120 may increase the sound corresponding to the image content.

For example, after a user selects image content by focusing on the image content, the processor 120 may increase a sound corresponding to the image content. In one or more examples, the processor 120 may track the line of sight of the user through the camera 180, and may increase the sound corresponding to the image content upon determination that the time at which the user's line of sight is located in the image content is greater than or equal to a threshold time.

As illustrated in FIG. 14, when the content selected by the user has no sound like the document content (1400A), the processor 120 may maintain the former sound output as illustrated in the right side of FIG. 14 (1400B).

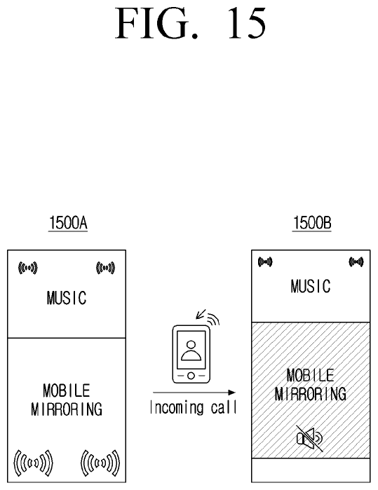

FIG. 15 is a diagram illustrating a mirroring operation, according to one or more embodiments of the disclosure.

The processor 120 may control the display 110 to display the first content in the first area and to display the second content in the second area, as illustrated in the left side of FIG. 15 (1500A). As shown in the right side of FIG. 15 (1500B), the first content may be mirrored with the user terminal, and the processor 120 may mute the sound corresponding to the first content and reduce the volume of the sound corresponding to the second content when the user terminal receives the call.

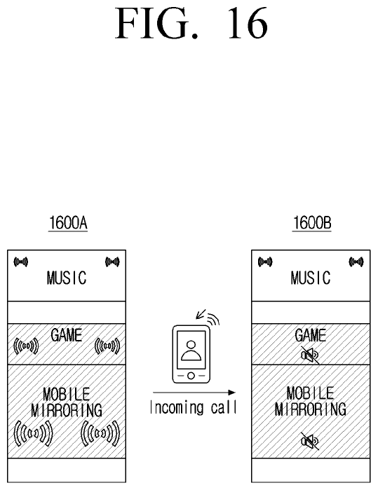

FIG. 16 is a diagram illustrating a mirroring operation, according to one or more embodiments of the disclosure.

The processor 120 may display the first content on a partial area of the first area, display the second content on the remaining area of the first area and a partial area of the second area, and display the third content on the remaining area of the second area.

For example, as shown in the left side of FIG. 16 (1600A), the processor 120 may display the mobile mirroring content on a partial area of the first area, display the game content on the remaining area of the first area and a partial area of the second area, and display the music content on the remaining area of the second area. The processor 120 may output sound corresponding to the mobile mirroring content through two lower speakers, and output sound corresponding to the game content and a sound corresponding to the music content through two other speakers such as the middle speakers for the game content and the upper speakers for the music content. The sound corresponding to the game content may have a volume greater than a sound corresponding to the music content.

When the user terminal receives a call as in the right side of FIG. 16 (1600B), the processor 120 may mute sound corresponding to the mobile mirroring content and a sound corresponding to the game content, and reduce the volume of the sound corresponding to the music content.

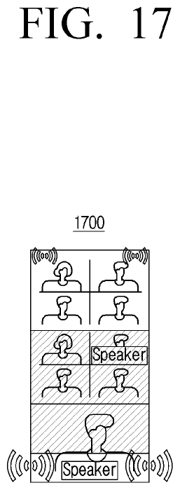

FIG. 17 is a diagram illustrating a multilateral video call according to one or more embodiments of the disclosure.

The processor 120 may display a screen (1700) corresponding to each of a plurality of other users when performing a multilateral video call. In this case, the processor 120 may arrange a screen corresponding to each of a plurality of other users in the first area and the second area based on at least one of a final utterance time point, a volume size, or a total utterance time of each of the plurality of other users.

For example, the processor 120 may output a screen, corresponding to other user who is uttering, in a partial area of the first area as the largest screen as shown in the bottom of FIG. 17 and may output a screen corresponding to each of the plurality of other users through a remaining area of the first area and the second area.

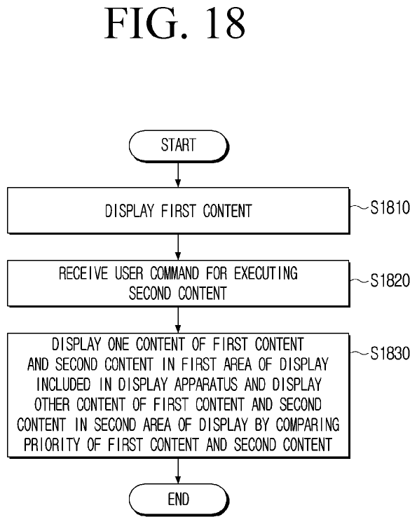

FIG. 18 is a flowchart illustrating a method for controlling a display apparatus according to one or more embodiments of the disclosure.

The first content is displayed in operation S1810. For example, if the first content is the only content being displayed, the first content may be displayed in an entire area of the display. The user command for executing second content is received in operation S1820. The user command may correspond to the user operating a device to select the second content, or the user speaking into a microphone and providing a verbal command to select the second content. In operation S1830, one content of the first content and the second content is displayed in a first area of the display by comparing a priority of the first content and the second content, and the other content of the first content and the second content is displayed on a second area of the display. The first area may be an area including a center of the display, and the second area may include at least a portion of a remaining area except for the first area in the display.

The displaying the first content in operation S1810 may include displaying the first content on a third region of the display, and the displaying in the second area in operation S1830 may include, based on receiving the user command and a priority of the first content being higher than a priority of the second content, displaying the first content in the first region and displaying the second content in the second region, and based on receiving the user command and a priority of the first content being lower than a priority of the second content, displaying the second content in the first region and display the first content in the second region. As understood by one of ordinary skill in the art, the operation S1820 may not require a user command, where a display apparatus may automatically execute the second content when a condition is satisfied such as, receiving the second content from a remote location, the triggering of an alarm for executing the second content, the execution of a particular application related to the second content, etc.

The method may further include identifying the priority based on a type of the first content and a type of the second content.

The method may further include controlling the display to display a focus on an edge of one of the first area and the second area; and based on receiving a user command for selecting the second region in a state where the focus is located for a threshold time or more in the second region or the focus is located in the second region, displaying the other content in the first region and display the one content in the second region.

The display may be larger than or equal to a threshold size or at a preset ratio.

The method may further include outputting sound corresponding to the one content through a first speaker closer to the first region than the second region among the plurality of speakers, and outputting sound corresponding to the other content through a second speaker closer to the second region than the first region among the plurality of speakers.

The outputting may include increasing volume of the sound corresponding to the one content or reducing volume of the sound corresponding to the other content.

The first content is content mirrored with a user terminal, and the method may further include, based on the user terminal receiving a call, muting sound corresponding to the one content and reducing volume of the sound corresponding to the other content.

The method may further include, based on a preset event occurring in the other content, increasing volume of the sound corresponding to the other content.

The method may further include changing at least one of a size of the first area, a position of the first area, a size of the second area, or a position of the second area based on at least one of an arrangement state of the display or a resolution of the one content.

According to various embodiments above, a display apparatus may display contents having high priority on a central portion of the display when providing a multi-view function, thereby reducing burden to the neck of the user.

The display apparatus may provide a user with user experience having more three-dimensional effect as a speaker to output sound of content is determined based on the position of display of content among a plurality of speakers.

Various embodiments of the disclosure may be implemented in software, including instructions stored on machine-readable storage media readable by a machine (e.g., a computer). An apparatus may call instructions from the storage medium, and execute the called instruction, including an electronic apparatus (for example, electronic apparatus A) according to the disclosed embodiments. When the instructions are executed by a processor, the processor may perform a function corresponding to the instructions directly or by using other components under the control of the processor. The instructions may include a code generated by a compiler or a code executable by an interpreter. A machine-readable storage medium may be provided in the form of a non-transitory storage medium. Herein, the term “non-transitory” only denotes that a storage medium does not include a signal but is tangible, and does not distinguish the case in which a data is semi-permanently stored in a storage medium from the case in which a data is temporarily stored in a storage medium.

According to one or more embodiments, the method according to the above-described embodiments may be provided as being included in a computer program product. The computer program product may be traded as a product between a seller and a consumer. The computer program product may be distributed online in the form of machine-readable storage media (e.g., compact disc read only memory (CD-ROM)) or through an application store (e.g., Play Store™ and App Store™) or distributed online (e.g., downloaded or uploaded) directly between to users (e.g., smartphones). In the case of online distribution, at least a portion of the computer program product may be at least temporarily stored or temporarily generated in a server of the manufacturer, a server of the application store, or a machine-readable storage medium such as memory of a relay server.

The various embodiments described above may be implemented in a recordable medium which is readable by a computer or a device similar to the computer using software, hardware, or the combination of software and hardware. In some cases, embodiments described herein may be implemented by the processor itself. According to a software implementation, embodiments such as the procedures and functions described herein may be implemented with separate software modules. Each of the software modules may perform one or more of the functions and operations described herein.

According to various embodiments described above, computer instructions for performing processing operations of a device according to the various embodiments described above may be stored in a non-transitory computer-readable medium. The computer instructions stored in the non-transitory computer-readable medium may cause a particular device to perform processing operations on the device according to the various embodiments described above when executed by the processor of the particular device. The non-transitory computer-readable medium is not a medium storing data for a short period of time such as a register, a cache, or a memory, but may refer to a medium that semi-permanently stores data and is readable by a machine. Specific examples of the non-transitory computer-readable medium may include a CD, a DVD, a hard disk drive, a Blu-ray disc, a USB, a memory card, and a ROM.

Each of the elements (e.g., a module or a program) according to various embodiments may be comprised of a single entity or a plurality of entities, and some sub-elements of the abovementioned sub-elements may be omitted, or different sub-elements may be further included in the various embodiments. Alternatively or additionally, some elements (e.g., modules or programs) may be integrated into one entity to perform the same or similar functions performed by each respective element prior to integration. Operations performed by a module, a program, or another element, in accordance with various embodiments, may be performed sequentially, in a parallel, repetitively, or in a heuristically manner, or at least some operations may be performed in a different order, omitted or a different operation may be added.

While example embodiments of the disclosure have been illustrated and described, the disclosure is not limited to the specific embodiments described above. It will be understood by those skilled in the art that various changes in form and details may be made therein without departing from the true spirit and full scope of the disclosure, including the appended claims and their equivalents.

What is claimed is:

1. A display apparatus comprising:
a display; and
at least one processor operatively connected to the display and configured to:
control the display to display first content, and
based on receiving a command for executing second content, (i) compare a first priority associated with the first content with a second priority associated with the second content, (ii) display one content of the first content and the second content in a first area of the display based on the comparison of the first priority with the second priority, and (iii) control the display to display the other content of the first content and the second content on a second area of the display based on the comparison of the first priority with the second priority,
wherein the first area is an area comprising a center of the display, and
wherein the second area comprises at least a portion of a remaining area excluding the first area of the display.

2. The display apparatus of claim 1, wherein the at least one processor is further configured to:
control the display to display the first content on a third area of the display,
based on receiving the command and based on a determination the first priority is higher than the second priority, control the display to display the first content in the first area and display the second content in the second area, and
based on receiving the command and based on a determination the first priority is lower than the second priority, control the display to display the second content in the first area and display the first content in the second area.

3. The display apparatus of claim 1, wherein the at least one processor is further configured to identify the first priority based on a type of the first content and the second priority based on a type of the second content.

4. The display apparatus of claim 1, wherein the at least one processor is further configured to:
control the display to display a focus on an edge of one of the first area and the second area; and
based on the focus being located for a threshold time or more in the second area or receiving a command for selecting the second area in a state where the focus is located in the second area, control the display to display the other content in the first area and display the one content in the second area.

5. The display apparatus of claim 1, wherein the display is larger than or equal to a threshold size or at a preset ratio.

6. The display apparatus of claim 1, further comprising:
a plurality of speakers,
wherein the at least one processor is further configured to:
output sound corresponding to the one content through a first speaker closer to the first area than the second area among the plurality of speakers, and
output sound corresponding to the other content through a second speaker closer to the second area than the first area among the plurality of speakers.

7. The display apparatus of claim 6, wherein the at least one processor is further configured to increase a volume of the sound corresponding to the one content or reduce a volume of the sound corresponding to the other content.

8. The display apparatus of claim 6, wherein the first content is content mirrored with a user terminal,
wherein the processor is further configured to, based on the user terminal receiving a call, mute the sound corresponding to the one content and reduce a volume of the sound corresponding to the other content.

9. The display apparatus of claim 6, wherein the at least one processor is further configured to, based on a preset event occurring in the other content, increase a volume of the sound corresponding to the other content.

10. The display apparatus of claim 1, wherein the at least one processor is further configured to change at least one of a size of the first area, a position of the first area, a size of the second area, or a position of the second area based on at least one of an arrangement state of the display or a resolution of the one content.

11. A method of controlling a display apparatus, the method comprising:
displaying first content;
receiving a command for executing second content;
comparing a first priority associated with the first content with a second priority associated with the second content; and
displaying one content of the first content and the second content in a first area of the display based on the comparing the first priority with the second priority, and displaying the other content of the first content and the second content on a second area of the display based the comparing of the first priority with the second priority,
wherein the first area is an area comprising a center of the display, and
wherein the second area comprises at least a portion of a remaining area excluding the first area of the display.

12. The method of claim 11, wherein the displaying the first content comprises displaying the first content on a third area of the display,
wherein the displaying in the second area comprises:
based on receiving the command and based on a determination the first priority associated with the first content is higher than the second priority associated with the second content, displaying the first content in the first area and displaying the second content in the second area; and
based on receiving the command and based on a determination the first priority associated with the first content is lower than the second priority associated with the second content, displaying the second content in the first area and display the first content in the second area.

13. The method of claim 11, further comprising:
identifying the first priority based on a type of the first content and the second priority based on a type of the second content.

14. The method of claim 11, further comprising:
controlling the display to display a focus on an edge of one of the first area and the second area; and
based on the focus being located for a threshold time or more in the second area or receiving a command for selecting the second area in a state where the focus is located in the second area, displaying the other content in the first area and display the one content in the second area.

15. The method of claim 11, wherein the display is larger than or equal to a threshold size or at a preset ratio.

16. A display apparatus comprising:
a display; and
at least one processor connected to the display and configured to control the display apparatus,
wherein the processor is further configured to:
control the display to display first content, and
based on receiving a command for executing second content, (i) compare a first priority associated with the first content with a second priority associated with the second content, (ii) display one content of the first content and the second content in a first area of the display based on the comparison of the first priority with the second priority, and (iii) control the display to display the other content of the first content and the second content on a second area of the display based on the comparison of the first priority with the second priority.

17. The display apparatus of claim 16, wherein the at least one processor is further configured to:
control the display to display the first content on a third area of the display,
based on receiving the command and based on a determination the first priority associated with the first content is higher than the second priority associated with the second content, control the display to display the first content in the first area and display the second content in the second area, and
based on receiving the command and based on a determination the first priority associated with the first content is lower than the second priority associated with the second content, control the display to display the second content in the first area and display the first content in the second area.

18. The display apparatus of claim 16, wherein the at least one processor is further configured to identify the first priority based on a type of the first content and the second priority based on a type of the second content.

19. The display apparatus of claim 16, wherein the at least one processor is further configured to:
control the display to display a focus on an edge of one of the first area and the second area; and
based on the focus being located for a threshold time or more in the second area or receiving the command for selecting the second area in a state where the focus is located in the second area, control the display to display the other content in the first area and display the one content in the second area.

20. The display apparatus of claim 16, wherein the display is larger than or equal to a threshold size or at a preset ratio.
